(19) United States
(12) Patent Application Publication
(10) Pub. No.: US 2025/0373182 A1
(43) Pub. Date: Dec. 4, 2025

(54) CONTROL METHOD TO ACHIEVE ZERO AND ULTRA-LOW SPEED OPERATION FOR BRUSHLESS DC MOTOR WITHOUT POSITION SENSOR

(71) Applicant: Qorvo US, Inc., Greensboro, NC (US)

(72) Inventors: Shao Zhang, Allen, TX (US); Wentao Yuan, Shanghai (CN); Chao Dong, Shanghai (CN); Jose I. Quinones, Melissa, TX (US)

(21) Appl. No.: 19/215,530

(22) Filed: May 22, 2025

Related U.S. Application Data
(60) Provisional application No. 63/655,128, filed on Jun. 3, 2024.

(51) Int. Cl. H02P 6/185; H02P 6/18; H02P 6/182

(52) U.S. Cl. CPC H02P 6/185; H02P 6/181; H02P 6/182; H02P 2207/05

(57) ABSTRACT

Disclosed is a system and a method for controlling a brushless direct current motor or a permanent magnet synchronous motor using inductance-based rotor position detection. Voltage pulses are applied to the motor windings and the resulting voltages are measured. The inductances of the windings are determined from the measured voltages, and the relationship between the measured inductances and their order is compared to determine the rotor position. The motor is then controlled based on the rotor position.

### RELATED APPLICATIONS

This application claims the benefit of provisional patent application Ser. No. 63/655,128, filed Jun. 3, 2024, the disclosure of which is hereby incorporated herein by reference in its entirety.

### FIELD OF THE DISCLOSURE

The present disclosure relates to a control system and method for sensor-less detection of motor rotor positions in brushless direct current (DC) motors and permanent magnet synchronous motors. The disclosed control system and method are usable during a rotor speed of zero and ultra-low speed regions of motor operation.

### BACKGROUND

Brushless direct current motors have been widely used in household appliances, automotive industries, and so on. High motor torque is always desired, including but not limited to, during low speeds and even zero speed scenarios. A position sensor is typically required to detect the rotor position to achieve this purpose. However, any position sensor usually increases the system volume, weight, and cost. Hence, more and more there is demand to achieve sensorless operation at the low speeds and zero speed scenarios. At present, the rotor position detection methods can be mainly divided into two categories. The first kind of method uses high-frequency signal injection, and the rotor position is detected by measured inductance. But this method requires having a high-precision current sensor and complex calculation in a microcontroller to achieve more accurate rotor position. Moreover, this method is sensitive to the motor parameters. The second kind of method uses the relationship between winding inductances and the rotor position caused by the salient pole effect. But one of the most significant drawbacks of this method is difficulty in detecting the permanent magnet pole. In other words, the motor could be reverse rotated unexpectedly if the permanent magnet pole is not detected correctly. Thus, there is a need for alternative methods for controlling brushless direct current motors or permanent magnet synchronous motors that do not rely on physical devices to detect rotor position because such physical devices are prone to failure or damage in harsh operating environments.

### SUMMARY

Disclosed is an intelligent motor controller that does not need any hardware position sensors, and therefore the system size, weight, and cost are not increased at all.

The disclosed control method generates continuous voltage pulses into the motor windings and simultaneously samples the voltages from the three phase windings of the motor. The simultaneous sampled three phase voltages are fed into the analog input pins on the disclosed controllers via a voltage divider. Hence, the solution can achieve much more accurate and reliable rotor position regardless of the motor parameters and the behavior/characteristics of the power inverter.

The control method keeps generating the voltage pulses at micro-second level, which is typically unachievable by a human being. Moreover, the consequent pulses are autonomously generated based on the previous calculated rotor position.

The control method to achieve zero and ultra-low speed operation for a brushless direct current motor without any position sensor includes, but is not limited to, the following:
An arrangement of two adjacent voltage pulses is disclosed to measure the three phase motor inductances with simultaneous sampling capability of the three phase motor winding voltages or currents.
Each phase inductance is accumulated with multiple cycles with the aim to get reliable inductance calculation regardless of the characteristics of the power inverter.
The rotor position is derived from the phase inductances with the status of the applied adjacent voltage pulses (also known as commutation state). The next pair of the adjacent voltage pulses is updated according to the calculated rotor position.
The disclosed method can detect the rotor position from both rotating directions, and it can switch between the disclosed startup method and any estimator-based methods (such as back electromotive force zero-crossing-based six-step control, or observer-based field-oriented control).

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a system diagram with an intelligent motor controller, 3-phase inverter, and motor.

FIG. 2 is a diagram showing six voltage pulses of a motor control for a brushless direct current motor.

FIG. 3A is a diagram showing the voltage pulse arrangement for the pair of AB&AC, in this case, the voltage pulse AB applied from the 3-phase inverter to the motor.

FIG. 3B is a diagram showing the voltage pulse arrangement for the pair of AB&AC, in this case, the two adjacent voltage pulses as a pair.

FIG. 4 is a table showing the relationship between the commutation state and inductance.

FIG. 5 is a diagram showing a rotor position derived from the voltage pair AB&AC and the inductance order due to forward rotation in case 1.

FIG. 6 is a diagram showing a rotor position derived from the voltage pair AB&AC and the inductance order due to forward rotation in case 2.

FIG. 7 is a diagram showing a rotor position derived from the pattern AB&AC and the inductance order due to reverse rotation in case 1.

FIG. 8 is a diagram showing a rotor position derived from the pattern AB&AC and the inductance order due to reverse rotation in case 2.

FIG. 9 is a block diagram that illustrates an interconnected system of components for an electric vehicle that employs the motor control system of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

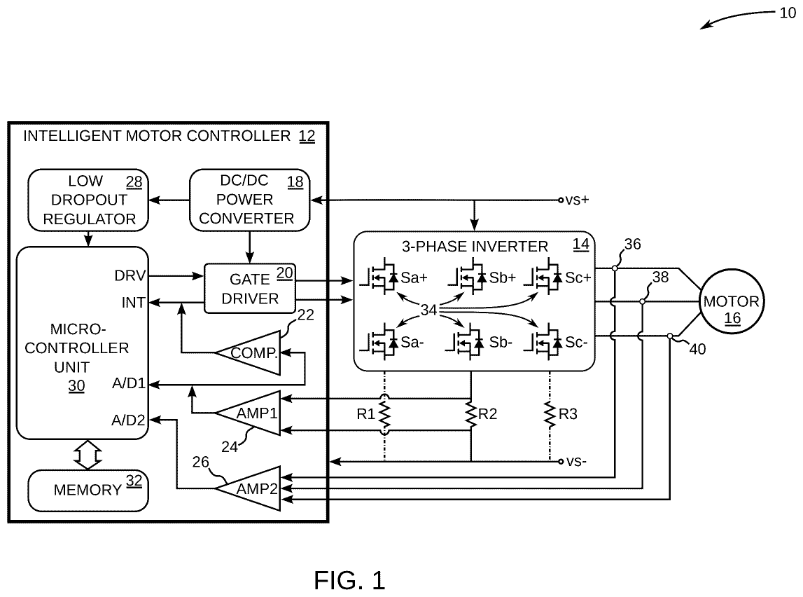

FIG. 1 discloses an embodiment of a motor control system 10, configured in accordance with the present disclosure. The motor control system 10 includes an intelligent motor controller 12, a 3-phase inverter 14, and a motor 16. The intelligent motor controller 12 is configured to control the 3-phase inverter 14, which generates current pulses that power the motor 16. The intelligent motor controller 12 has analog circuitry, including a direct current-to-direct current (DC/DC) power converter 18, a gate driver 20, a comparator 22, a first amplifier 24, a second amplifier 26, and a low dropout regulator 28. In some embodiments, the comparator 22, first amplifier 24, and second amplifier 26 may receive power from the DC/DC power converter 18 or, in other embodiments, from the low dropout regulator 28. The 3-phase inverter 14 receives power from an external power source.

The intelligent motor controller 12 also includes digital circuitry, comprising a microcontroller unit 30 powered by the low dropout regulator 28. The digital circuitry further includes memory 32 configured with firmware that is executed by the microcontroller unit 30 to generate a drive control signal at a drive control output DRV. In operation, the drive control signal directs the gate driver 20 to generate drive signals for the 3-phase inverter 14. In the embodiment depicted in FIG. 1, the 3-phase inverter 14 is made up of power transistors 34 configured as digital switches that pass current pulses to power the motor 16 in response to gate signals generated by the gate driver 20. The power transistors 34 are metal oxide semiconductor field-effect transistors. Alternative types of power transistors include insulated gate bipolar transistors.

In the embodiment of FIG. 1, the intelligent motor controller 12 is an integrated circuit that integrates the analog circuits with the digital circuits. During operation, the DC/DC power converter 18 receives power from an external voltage source (not shown) coupled between a VS+ terminal and a VS− terminal. The DC/DC power converter 18 then outputs converted power at voltage levels that supply the gate driver 20 and the low dropout regulator 28. In turn, the low dropout regulator 28 provides regulated power to the microcontroller unit 30 and memory 32.

Three current-sensing resistors R1, R2, and R3, one for each phase of the motor 16, may be coupled between the 3-phase inverter 14 and the VS− terminal. In FIG. 1, the first amplifier 24 has a differential input coupled across the second resistor R2 to sense the current flowing through a winding of the motor 16. The differential input of the first amplifier 24 may optionally be coupled across one of the current sensing resistors R1 or R3. An output of the first amplifier 24 is coupled to a first analog-to-digital input A/D1 of the microcontroller 30 and to an input of the comparator 22. The comparator 22 has an output coupled to an interrupt input INT of the microcontroller unit 30, which also receives feedback from the gate driver 20. Amplified current sense voltages output from the first amplifier 24 are converted to current sense digital values by the first analog-to-digital converter A/D1 for further processing by the microcontroller unit 30.

The second amplifier 26 has three winding voltage inputs coupled to a first motor winding terminal 36, a second motor winding terminal 38, and a third motor winding terminal 40, respectively. The second amplifier 26 has an output coupled to a second analog-to-digital input A/D2. During operation, the second amplifier 26 is configured to amplify motor winding voltage pulses at the first motor winding terminal 36, the second motor winding terminal 38, and the third motor winding terminal 40. The second analog-to-digital input A/D2 is configured to convert amplified motor winding voltage pulses into digital values that are processed by the microcontroller unit 30 to determine an instantaneous rotor position of the motor 16.

### Arrangement of Two Adjacent Voltage Pulses

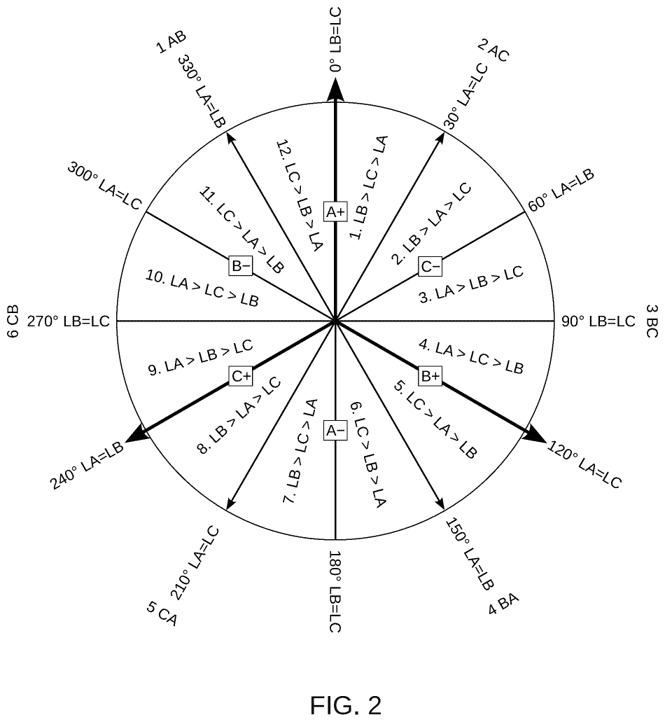

FIG. 2 illustrates six motor winding voltage pulses (AB, AC, BC, BA, CA, and CB) used to control motor 16, which may be a brushless DC motor or a permanent magnet synchronous motor. The letters A, B, and C represent phase A, phase B, and phase C, respectively. LA, LB, and LC denote the motor phase inductances.

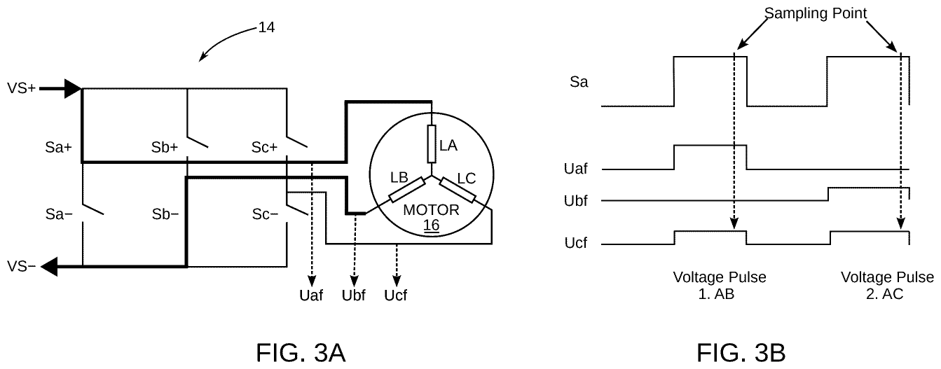

Measuring each phase inductance or impedance requires two adjacent voltage pulses, as each pulse contains information for two phase impedances. FIGS. 3A and 3B provide examples of using two adjacent voltages, AB and AC, to identify LA, LB, and LC. When applying the voltage pulse AB (as shown in FIG. 3A), a DC current flows from phase A winding to phase B winding, while phase C winding is floated. During this period, motor winding terminal voltages Uaf, Ubf, and Ucf are measured simultaneously by way of sample and hold on three inputs of the second analog-to-digital converter A/D2. Similarly, when applying the voltage pulse AC, a DC current flows from phase A winding to phase C winding, while phase B winding is floated. The motor winding terminal voltages are sampled simultaneously before the falling edge of the voltage pulse as shown in FIG. 3B. By combining the measured voltages during both pulses, all three phase impedances can be derived.

There are six adjacent voltage pairs: AB&AC, AC&BC, BC&BA, BA&CA, CA&CB, and CB&AB. Each pair covers a 60° span, and collectively, the six pairs provide impedance data for the entire 360° range. Note that the duration of each voltage pulse in any pair is designed to be configurable independently, allowing for adjustable torque generation according to the actual rotor position.

### Motor Phase Inductance Calculation

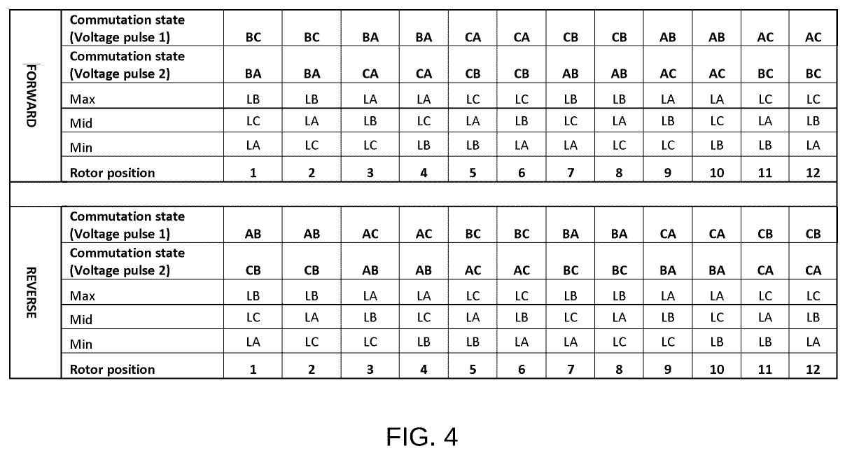

Inductances are calculated using the measured motor winding voltages. A table provided in FIG. 4 illustrates the relationship between the voltage pulses or commutation states and inductances when the rotor is at different positions. For example, when applying pulse AB, LA is directly proportional to (Uaf-Ucf), and LB is directly proportional to (Ucf-Ubf). Similarly, with pulse AC, LA is directly proportional to (Uaf-Ubf), and LC is directly proportional to (Ubf-Ucf). Using the two voltage pulses, the three phase motor inductances, LA, LB, and LC, can be calculated accordingly from Uaf, Ubf, and Ucf.

The same principle can be applied to the other five voltage pairs. Notably, the inductance calculation is independent of the inverter parameters since the voltage drop caused by power modulation-doped field-effect transistors or insulated gate bipolar transistors are excluded from Uaf, Ubf, and Ucf. These three measured voltages precisely represent the motor winding characteristics, which leads to accurate rotor position detection.

Furthermore, the inductance is accumulated over a configurable number of cycles, helping to reduce inductance measurement noise and disturbances. The number of accumulations is a configurable parameter. Although increasing the number of accumulations results in smoother inductance calculations, it reduces the transient response performance on inductance measurement. Therefore, the number of accumulations is designed as a configurable parameter to achieve a desired performance for inductance calculation.

### Motor Rotor Position Calculation

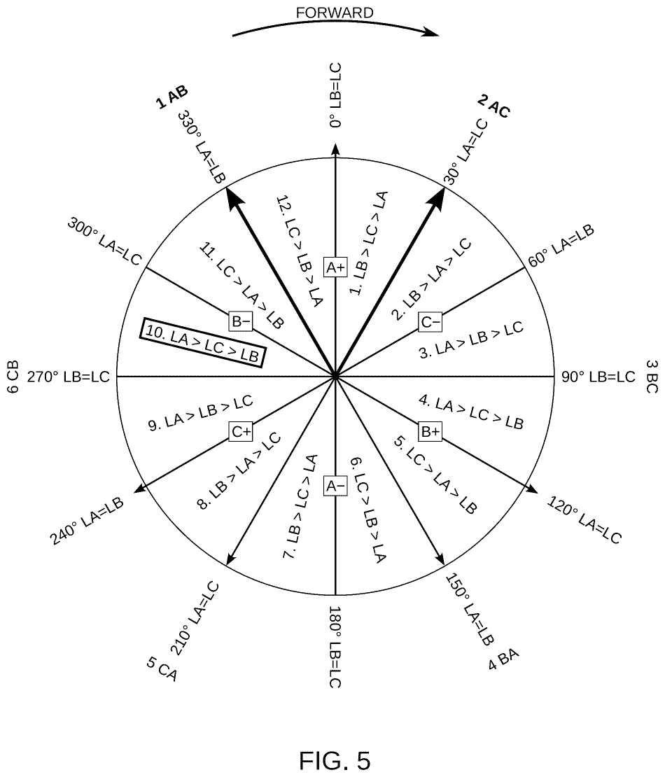

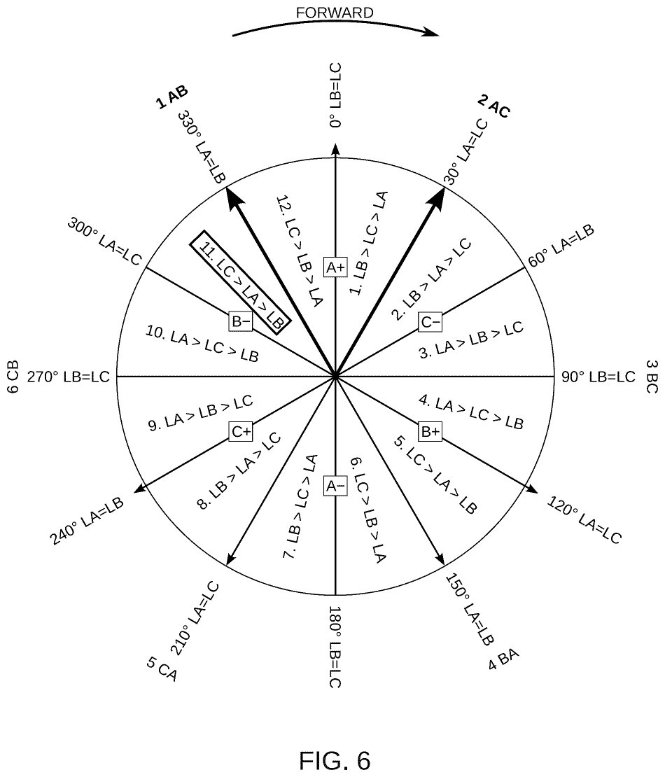

Two key elements to determine the rotor position are the pair of voltage pulses (i.e., commutation states) and the order of the three phase motor inductances. FIG. 5 and FIG. 6 illustrate the rotor position determination using the voltage pattern of AB&AC. For example, during forward rotation, when applying AB and BC pulses on the motor windings, if the measured inductance order is LA>LC>LB, the rotor position will be between 270° and 300° (as shown in FIG. 5). Alternatively, if the measured inductance order is LC>LA>LB, the rotor position will be between 300° and 330° as illustrated in FIG. 6.

The same principle can be applied to the other five pairs of voltage patterns: AC&BC, BC&BA, BA&CA, CA&CB, and CB&AB. As a result, the rotor position can be detected throughout the entire 360° span. Referring back to the table of FIG. 4, the rotor position for a 360° revolution is given.

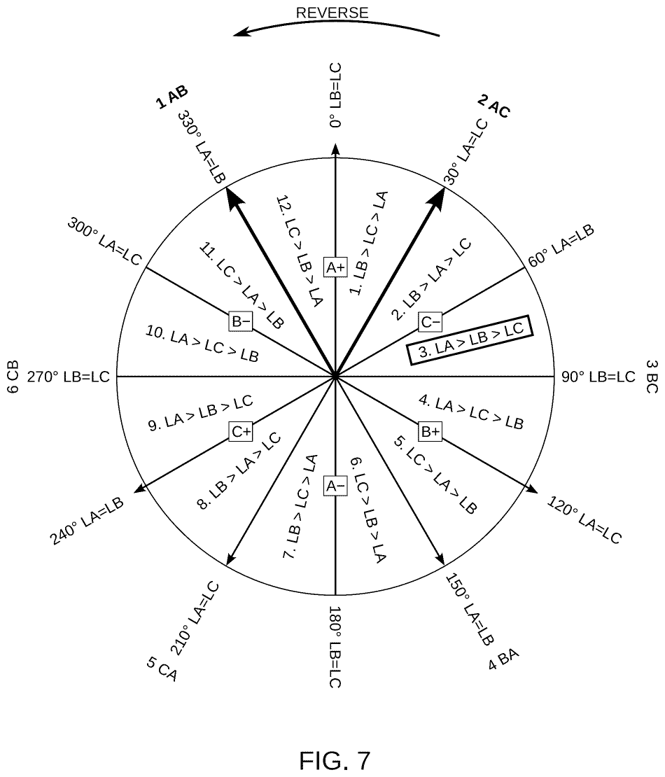

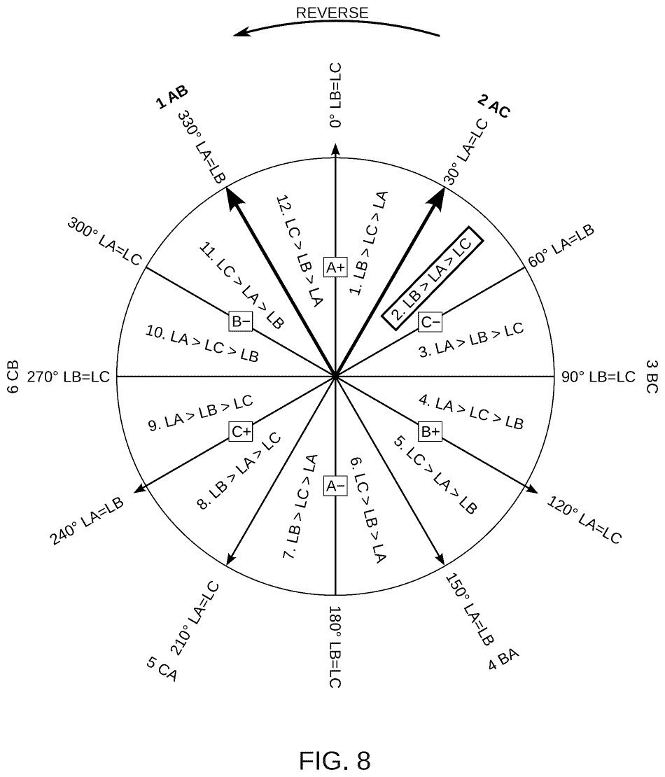

FIG. 7 and FIG. 8 illustrate the rotor position using the voltage pattern of AB&AC during reverse rotation. For instance, when applying AB and BC pulses on the motor windings during reverse rotation, if the measured inductance order is LA>LB>LC, the rotor position will be between 60° and 90° as shown in FIG. 7. Alternatively, if the measured inductance order is LB>LA>LC, the rotor position will be between 30° and 60° as illustrated in FIG. 8.

### Bidirectional Rotation and Hybrid Rotor Position Modes

The disclosed control method demonstrates its advantages in both zero and ultra-low speed regions. The control method stored as firmware in memory 32 (FIG. 1) is designed to transition to back electromotive force (EMF) detection for six-step operation once the motor speed increases and a back EMF becomes larger. When field-oriented control is employed, the zero and ultra-low speed control method can switch between sensorless observer-based mode and an alternative mode.

As a hybrid rotor position mode, there are multiple sources for the rotor positions: The observer-based rotor position, and the inductance-based rotor position. The former one is used once the estimator becomes reliable, which is usually after the motor reaches a certain speed threshold. The latter one is used during the initial startup or ultra-low speed region. By combining both the rotor positions, the disclosed control method achieves coverage of both the zero speed and higher speed regions. On the other hand, if the motor speed is ramping down from higher speeds to zero speed, the control method can be switched from the sensorless observer-based mode into the inductance-based rotor position mode.

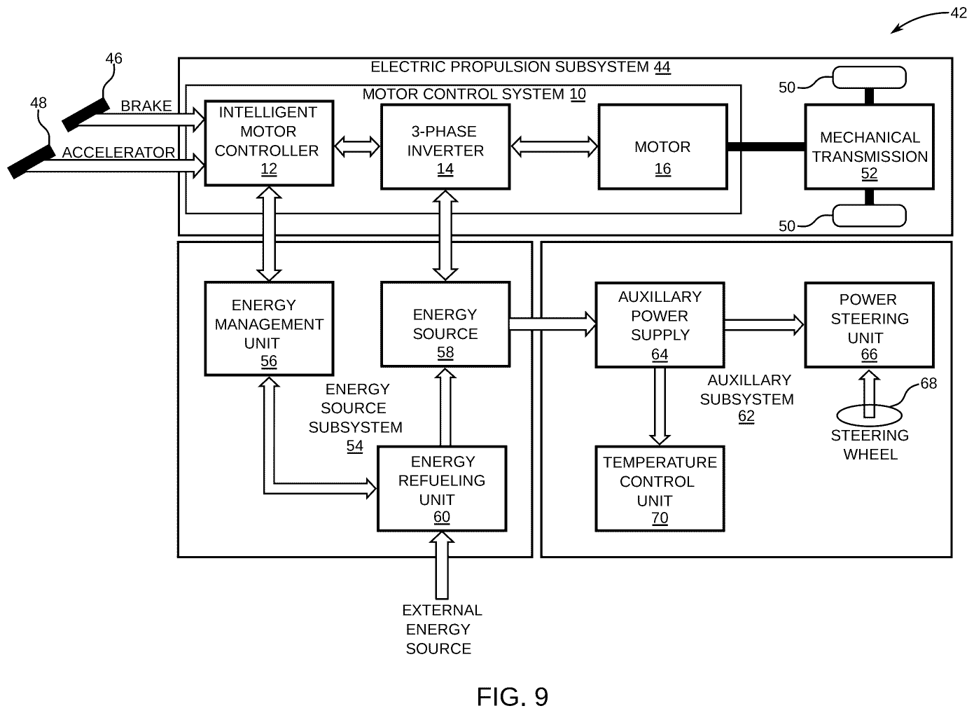

The motor control system 10 may be employed in various applications, including an electric vehicle application. Referring to FIG. 9, a block diagram illustrates an interconnected system of components for an electric vehicle 42. The electric propulsion subsystem 44 includes the motor control system 10. In this embodiment, the intelligent motor controller 12 is operatively connected to a brake 46 and an accelerator 48 to receive inputs related to vehicle deceleration and acceleration, respectively. The intelligent motor controller 12 processes these inputs and regulates the flow of electrical energy to the 3-phase inverter 14. As detailed in previous sections, the 3-phase inverter 14 modulates the electrical power in response to signals from the intelligent motor controller 12 and supplies this power to the motor 16. The motor 16 converts the electrical energy into mechanical energy, which is then transmitted to the wheels 50 of the vehicle through a mechanical transmission 52.

Adjacent to the electric propulsion subsystem 44 is an energy source subsystem 54, which includes an energy management unit 56 that oversees the distribution and conservation of electrical energy within the electric vehicle 42. The energy management unit 56 is connected to an energy source 58, such as a rechargeable battery or fuel cell, which provides the primary electrical energy for the electric vehicle 42. Additionally, an energy refueling unit 60 is incorporated to facilitate the replenishment of the energy source 58 when it is depleted.

Furthermore, an auxiliary subsystem 62 is incorporated to manage non-propulsion related functions. The auxiliary power supply 64 derives energy from the energy source 58 and channels it to various auxiliary components, including a power steering unit 66 that receives power to assist in the manipulation of the steering wheel 68, and a temperature control unit 70 that maintains the thermal conditions of the vehicle's systems. The control signal flow and energy flow between the subsystems and components are represented by arrows.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A method performed by a processor in a brushless direct current (BLDC) motor control system, the method comprising:
generating drive control signals that direct a driver to apply voltage pulses to pairs of motor windings of a BLDC motor;
substantially simultaneously measuring, via an analog-to-digital converter in communication with the processor, terminal voltages generated across each of the motor windings induced by the applied voltage pulses and converting these measured voltages into digital values;
calculating inductances of the motor windings based on the converted digital values of the motor winding terminal voltages, wherein the inductance is calculated using proportional relationships derived from the measured terminal voltages during the application of specific voltage pulses; and
determining a substantially instantaneous rotor position of the BLDC motor by comparing an order of the calculated inductances with predetermined inductance patterns of predetermined rotor positions.

2. The method of claim 1 further comprising calculating each phase inductance from multiple cycles of applied voltage pulses to accumulate reliable inductance calculations regardless of characteristics of the driver.

3. The method of claim 1 further comprising:
generating continuous voltage pulses into the motor windings via the driver at a micro-second level; and
automatically updating subsequent pairs of adjacent voltage pulses based on the previously calculated rotor position.

4. The method of claim 1 further comprising applying the voltage pulses sequentially to different pairs of the motor windings, each pair covering a specific segment of the rotor's rotation.

5. The method of claim 1 further comprising detecting the rotor position from both a forward rotating direction and a reverse rotating direction.

6. The method of claim 1 further comprising sampling the terminal voltages substantially simultaneously before a falling edge of each voltage pulse.

7. The method of claim 1 further comprising:
accumulating inductance values over a configurable number of cycles to reduce measurement noise; and
configuring the number of accumulations based on desired performance characteristics for inductance calculation.

8. The method of claim 1 wherein the processor is a microcontroller.

9. The method of claim 1 further comprising:
determining a rotor position for both forward and reverse rotations by comparing calculated inductances with pre-stored patterns corresponding to specific voltage pulse pairs;
selecting a subsequent pair of adjacent voltage pulses based on the determined rotor position.

10. The method of claim 1 further comprising:
transitioning the BLDC motor from an inductance-based rotor position mode to a back electromotive force (EMF) detection mode when the motor speed increases and a back EMF becomes larger; and
maintaining continuity of motor operation in the BLDC motor during the transition.

11. A non-transitory computer-readable medium having stored thereon instructions that, when executed in a brushless direct current (BLDC) motor control system, cause the system to perform operations comprising:
generating drive control signals that direct a driver to apply voltage pulses to pairs of motor windings of a BLDC motor;
substantially simultaneously measuring, via an analog-to-digital converter, terminal voltages generated across each of the motor windings induced by the applied voltage pulses and converting these measured voltages into digital values;
calculating inductances of the motor windings based on the converted digital values of the motor winding terminal voltages, wherein the inductance is calculated using proportional relationships derived from the measured terminal voltages during the application of specific voltage pulses; and
determining a substantially instantaneous rotor position of the BLDC motor by comparing an order of the calculated inductances with a pre-stored pattern of rotor positions.

12. The non-transitory computer-readable medium according to claim 11 wherein the instructions further cause the system to calculate each phase inductance from multiple cycles of applied voltage pulses to accumulate reliable inductance calculations regardless of characteristics of the driver.

13. The non-transitory computer-readable medium according to claim 11 wherein the instructions further cause the system to perform operations comprising:
generating continuous voltage pulses into the motor windings via the driver at a micro-second level; and
automatically updating subsequent pairs of adjacent voltage pulses based on an immediately previously calculated rotor position.

14. The non-transitory computer-readable medium according to claim 11 wherein the instructions further cause the system to apply the voltage pulses sequentially to different pairs of the motor windings, each pair covering a specific segment of the rotor's rotation.

15. The non-transitory computer-readable medium according to claim 11 wherein the instructions further cause the system to switch between a rotor position detection mode and an estimator-based method as the motor speed increases beyond a preset motor speed threshold.

16. The non-transitory computer-readable medium according to claim 11 wherein the instructions further cause the system to detect the rotor position from both a forward rotating direction and a reverse rotating direction.

17. The non-transitory computer-readable medium according to claim 11 wherein the instructions further cause the system to sample the terminal voltages before a falling edge of each voltage pulse.

18. The non-transitory computer-readable medium according to claim 11 wherein the instructions further cause the system to perform operations comprising:
accumulating inductance values over a configurable number of cycles to reduce measurement noise; and
setting the number of accumulations according to target performance metrics for inductance measurement accuracy and responsiveness.

19. The non-transitory computer-readable medium according to claim 11 wherein the instructions further cause the system to perform operations comprising:
determining a rotor position for both forward and reverse rotations by comparing calculated inductances with pre-stored patterns corresponding to specific voltage pulse pairs; and
selecting a subsequent pair of adjacent voltage pulses based on the determined rotor position.

20. The non-transitory computer-readable medium according to claim 11 wherein the instructions further cause the system to perform operations comprising:
transitioning from an inductance-based rotor position mode to a back EMF detection mode when the motor speed reaches a predetermined threshold; and
maintaining continuity of motor operation during the transition.
